(19) United States
(12) Patent Application Publication
(10) Pub. No.: US 2006/0059530 A1
(43) Pub. Date: Mar. 16, 2006

(54) Distributed configuration of entertainment devices

(75) Inventors: Howard L. Spielman, San Francisco, CA (US); Darren L. Clark, Concord, CA (US)

Correspondence Address: Hugh H. Matsubayashi;MacPherson Kwok Chen & Heid, LLP, Suite 226, 1762 Technology Drive, San Jose, CA, 95110, US

(73) Assignee: E-Cast, Inc., San Francisco, CA (US)

(21) Appl. No.: 10/942,363

(22) Filed: Sep. 15, 2004

(51) Int. Cl. H04N 5/445; H04N 7/173; H04N 7/16; G06F 13/00

(52) U.S. Cl. 725/132; 725/140; 725/152; 725/50

(57) ABSTRACT

Methods and systems for managing configuration settings on remote entertainment devices are described. The method may include: storing values for a first subset of configuration settings from the set of configuration settings, each of the values for the first subset having an associated precedence level; storing values for a second subset of configuration settings, each of the values for the second subset having an associated precedence level; and transmitting a third subset of configuration setting values containing values from the first and second subset of configuration settings to a remote entertainment device.

### BACKGROUND

Traditional entertainment devices for out-of-home use, for example in restaurants or bars, are typified by the jukebox that plays selected vinyl records or compact discs after the insertion of coins or paper currency.

A company may develop and market a particular entertainment device platform, which may be licensed to a manufacturer that manufactures the entertainment device. This device may be sold to operators who, in turn, form agreements with individual venues to locate an entertainment device or units at that venue. Patrons of the venue may operate the entertainment device to provide the desired service, such as to play a selected song or display a selected music video. In many cases, the entertainment device hardware is owned by the operator, who forms some sort of revenue agreement with the venue owner.

An operator may own large numbers of entertainment devices that are installed and operated in a widely dispersed geographic region. In the past, conventional jukebox operators would personally visit each venue in order to update the music selection and to monitor the number of song plays for each individual entertainment device. These operators would have “routes” they would travel regularly in order to visit, access, and update their various entertainment devices. Later, network-enabled entertainment devices were developed so that new music could be distributed by a central host system to the network-enabled entertainment devices without requiring a human operator to manually install new storage media (e.g., vinyl records or compact discs). The system administrator may create configuration and setting updates for each of the entertainment devices at the host system. However, when an individual operator begins to run large numbers of entertainment devices, the management of these devices may become cumbersome and time consuming. Similarly, manual administration of the settings at the central host system can also become overwhelming if changes need to be made to large groups of entertainment devices one at a time.

Accordingly, it may be desirable to provide a system for the remote management of entertainment devices.

### SUMMARY OF THE INVENTION

In accordance with embodiments of the present invention, a method of managing a remote entertainment device having a set of configuration settings is provided, comprising: storing values for a first subset of configuration settings from the set of configuration settings, each of the values for the first subset having an associated precedence level; storing values for a second subset of configuration settings, each of the values for the second subset having an associated precedence level; and transmitting a third subset of configuration setting values containing values from the first and second subset of configuration settings to a remote entertainment device.

In accordance with embodiments of the present invention, a host system for managing a remote entertainment device having a plurality of configuration settings is provided, comprising: a configuration database storing a plurality of values for each configuration setting, each of the plurality of values having an associated precedence level used to determine which of the plurality of values to apply to each configuration setting on the remote entertainment device; and a host system controller configured to: compile a subset of configuration setting values from the set of configuration setting values; and transmit the subset of configuration setting values to the remote entertainment device.

In accordance with embodiments of the present invention, a method of updating a remote entertainment device having a set of configuration settings is provided, comprising: assigning a first set of values to a first subset of configuration settings from the set of configuration settings; receiving a second set of values for a second subset of configuration settings over a network connection; compiling a group of configuration setting values from the first and second sets of values such that such that if a configuration setting value from the first set of values applies to the same configuration setting as a configuration setting value from the second set of values, selecting the value from the second set of values to apply to the remote entertainment device; and transmitting the group of configuration setting values to the remote entertainment device.

In accordance with embodiments of the present invention, a method of updating configuration settings on remote entertainment devices is provided, comprising: providing a configuration setting interface to a user over a network connection; receiving a first set of configuration setting values from the user over the network connection; and transmitting the first set of configuration setting values to a plurality of remote entertainment devices.

In accordance with embodiments of the present invention, a method of configuring a plurality of entertainment devices is provided, comprising: storing default values for a plurality of configuration settings governing operation of the plurality of entertainment devices; providing an interface to a user for entering values for the configuration settings; receiving configuration setting values from the user; and propagating a set of configuration setting values to a plurality of jukebox systems, the propagated configuration setting values including the received configuration setting values and the default values for which there are no corresponding received configuration setting values.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 is a block diagram of an exemplary environment for embodiments of the present invention.

FIG. 2 is a block diagram of an exemplary host system.

FIG. 3 is a block diagram of an exemplary entertainment device.

FIG. 4 is a block diagram illustrating an exemplary hierarchy of precedence levels for a system of entertainment devices.

FIG. 5 shows a portion of an exemplary Setting Library.

FIGS. 6A-6B show portions of an exemplary Setting Table.

FIGS. 7-12 show screen shots of an exemplary management interface.

FIG. 13 is a flowchart showing an exemplary configuration setting update process.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

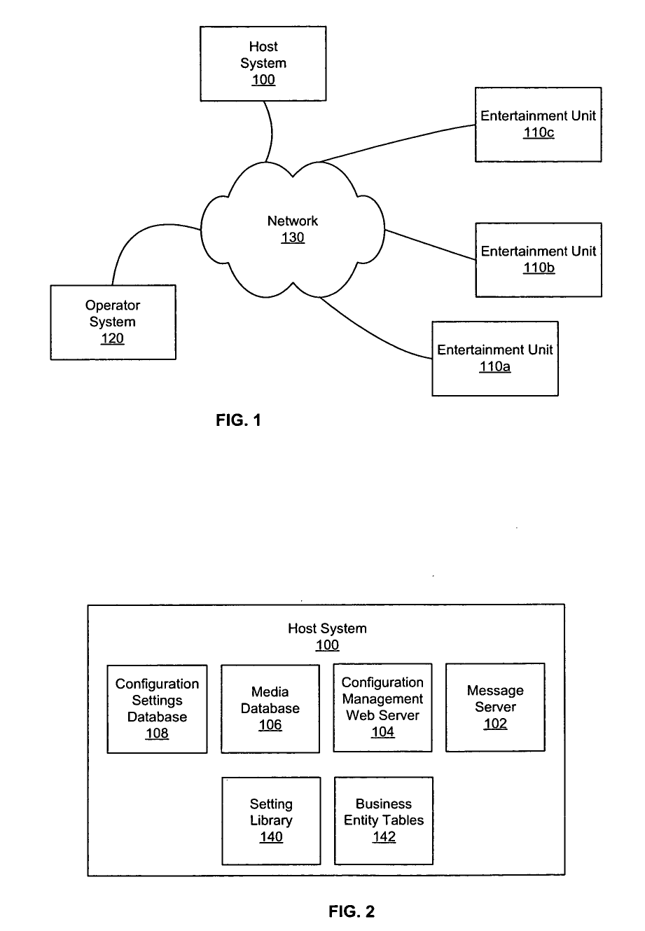

FIG. 1 shows a block diagram of an exemplary environment for embodiments of the present invention. A host system 100, one or more remote entertainment devices 110, and an operator management system 120 are couplable over a network 130. The network 130 may comprise, for example, the internet, and the various systems 100, 110, and 120 may connect to the network 130 via various mechanisms, as would be understood by those of ordinary skill in the art. For example, the systems may have a broadband connection to the internet, and may be continuously or intermittently coupled to the network 130.

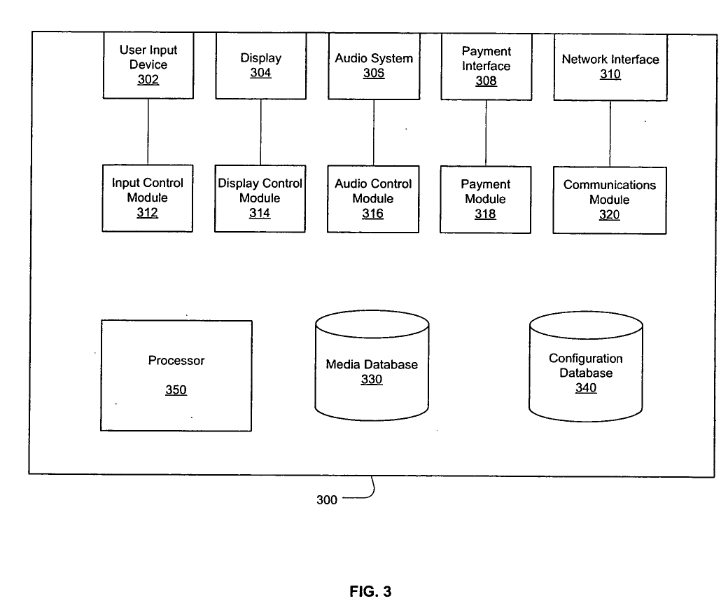

The host system 100 may comprise a central management system for controlling the various entertainment devices 110. This host system 100 may take various forms, one example of which is shown in FIG. 2. The host system 100 shown in FIG. 2 comprises multiple components which may be executed on a single server or across multiple servers. The illustrated host system 100 is only exemplary, and in other embodiments, the host system 100 may include greater or fewer components. As shown, the host system 100 comprises a message server 102 which can transmit and receive messages to and from the entertainment devices 110. The host system 100 may further comprise a configuration management web server 104, which controls the user interface application accessed by the operator management system 120. A media database 106 is provided for storing the entertainment content. The media database 106 may comprise, e.g., a storage subsystem containing a database of digital audio files, multimedia files, and game files. The media database 106 may further store metadata associated with the entertainment content, such as, e.g., title, artist, and album information corresponding to each musical song file. Finally, the host system 100 may further comprise a Setting Library 140, Business Entity Tables 142, and a configuration settings database 108, which stores information regarding various configuration settings available for the entertainment devices 110, as will be described in greater detail below.

The entertainment devices 110 may comprise any of a variety of network-enabled entertainment devices, such as, e.g., freestanding jukeboxes, wall mounted jukeboxes, countertop units, and dedicated gaming units. These entertainment devices 110 may provide users with entertainment content in various forms, such as, e.g., audio, video, graphics, video games, software, text, and combinations thereof. For example, a jukebox may enable customers to select songs to play, and a countertop unit may enable customers to read the news, view photographs, and play games. The countertop unit further be configured to also allow customers to request songs and/or music videos to be played. These entertainment devices 110 may be located, e.g., in a bar, restaurant, or other facility open to the public, in order to generate revenue by providing the entertainment content in exchange for payment from users, or free to users, but paid for by operators or venue managers.

In accordance with embodiments of the present invention, each entertainment device 110 may include a plurality of configuration settings that control the operation of the entertainment device 110. These configuration settings may control the way in which the entertainment device 110 interacts with consumers. For example, a jukebox may include settings corresponding to the language in the user interface, the features available to consumers, whether filters, such as adult content or music genre filters, are applied to the catalog of songs available to consumers, the cost per song, the order of song playback, whether free songs are played in between consumer requests, and the time delay between user requests before the jukebox begins playing random, unpurchased songs. In addition, these configuration settings may control the operation of the entertainment device 110 and the interaction of the entertainment device 110 with the host system. For example, these operational configuration settings may correspond to the reboot frequency, the frequency with which the entertainment device reports to the host system, the number of days the entertainment device may operate without reporting revenue and performance to the host system, and the URL for authorizing credit card purchases. These configuration settings, among others, may need to be set by different users, depending on the nature of the settings, as will be described below.

The operator management system 120 may comprise a computer system used by an operator who owns or manages one or more of the entertainment devices 110a-110c. The operator management system 120 may provide the operator with a user interface for configuring the settings on one or more of the entertainment devices 110a-110c. This operator may access the user interface using, e.g., a web browser, as will be described in greater detail below.

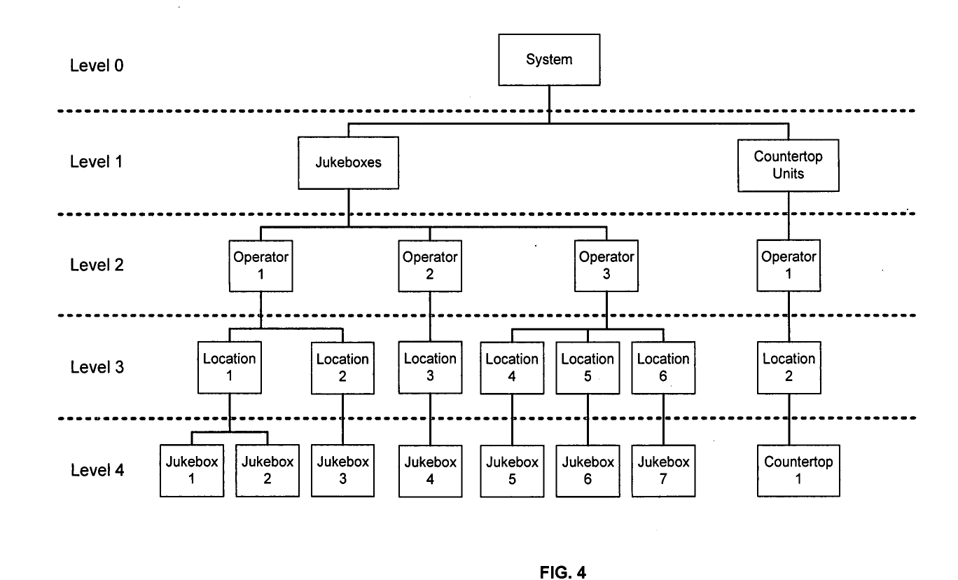

FIG. 3 is a block diagram of an exemplary entertainment device. The illustrated entertainment device comprises a jukebox 300. The jukebox 300 may take various forms, but in the illustrated embodiment comprises a user input device 302, which enables a customer at a venue to input commands into the jukebox 300. The user input device 302 may comprise, e.g., a keyboard, a touchpad, a mouse, a touch screen, or other input device, as would be understood by those of ordinary skill in the art. The jukebox 300 may further comprise a display 304, which may comprise, e.g., a computer monitor. The display 304 can be used to produce the visual entertainment services requested by customers. The display 304 may also be used to attract customers to the device and to enable authorized personnel to manage the device. In addition, an audio system 306 may be provided for generating the audio entertainment services requested by the customer. The audio system 306 may comprise an amplifier and audio speakers for playing music. In other embodiments, the audio system 306 may couple to an amplifier and/or speakers located elsewhere in the venue external to the jukebox 300. A payment interface 308 may be provided for receiving payment from customers in exchange for providing the entertainment service. In some embodiments, the payment interface 308 may comprise a coin and/or bill collector for receiving cash or token payment, a debit/credit card reader for reading the magnetic strip on customer debit or credit cards and for requesting payment authorization from the financial services provider associated with that debit or credit card, a smart card reader, any combination of the above, or any other payment receiving mechanism. A network interface 310 provides an interface between the jukebox 300 and the network 130 and may comprise, e.g., an RJ-11 port, a wireless adapter, or a modem. The jukebox system 300 also comprises an input control module 312, a display control module 314, an audio control module 316, a payment module 318, and a communications module 320 to provide computer control of the various components described above. A media database 330 for storing the entertainment media and a configuration database 340 for storing various configuration setting values are also provided as will be described in greater detail below. Finally, one or more processors 350 may be provided for executing the various functions for the jukebox 300. The jukebox 300 may be implemented using, for example, standard personal computer hardware and architecture.

When deploying large numbers of entertainment devices across multiple locations, it may be desirable to provide the ability to configure the entertainment devices to meet the specific needs and preferences of the particular venues. In addition, it may further be desirable to provide a network accessible interface, such as a web-based application, so that remote operators may configure the entertainment devices without physically accessing each device. This can enable any authorized user to modify the value of any configuration setting of any device to which that user has privileges without actually having to be physically present at the device. Because many operators have entertainment devices spread across substantial geographic ranges, the ability to update configuration settings remotely without having to physically travel along their routes can save the operators a considerable amount of time.

In addition, in some embodiments, it may be further be desirable for system administrators to remotely manage entertainment devices. This remote management may include providing default values for the various configuration settings, which can then be customized by the operators and venue managers, and may also include overriding the operator and venue manager settings. This remote management may be particularly useful because system level personnel often never physically visit the venue locations.

It may further be desirable in some embodiments to update a configuration setting, and then apply that updated configuration setting to a plurality of entertainment devices. This can provide a significant convenience to operators having large numbers of entertainment devices. Without this functionality, these operators would have to apply the same configuration setting change individually to each of their devices. In addition, system administrators may be able to make system-wide changes to all of the entertainment devices in the system. In some cases, the configuration settings accessible to the system administrator are not accessible to operators and/or venue managers, so only the system administrator may make changes to these settings. In other cases, multiple users may have the ability to change the same configuration setting.

In situations where multiple users have the ability to make changes to the same configuration settings, there arises the potential for two users to enter different updated values for the same setting. In accordance with one aspect of the present invention, configuration setting values entered by users are associated with a precedence level. When multiple values are entered for the same configuration setting, a precedence-based framework is provided for assigning a single value to that setting and applying that setting value to one or more entertainment devices 110. In accordance with another aspect of the present invention, when two configuration setting values conflict (such as, e.g., when both values have the same precedence level), a time-based arbitration may be used to select a single value to apply.

The use of precedence-based tiers for assigning values to configuration settings can also facilitate the management of large numbers of devices by enabling a default configuration setting value to be entered at a high level tier and be propagated to all entertainment devices at lower levels. Then, if an operator or administrator wishes to make a change at a lower level, these changes will have precedence over the values set at the high level tier and will be applied to the appropriate entertainment devices. Multiple tiers may be provided so that the lower level changes can be applied to individual devices or to groups of devices. Thus, a single operator who manages multiple entertainment devices located in distributed physical sites may manage the configuration settings of a plurality of that operator's systems using a single updating step.

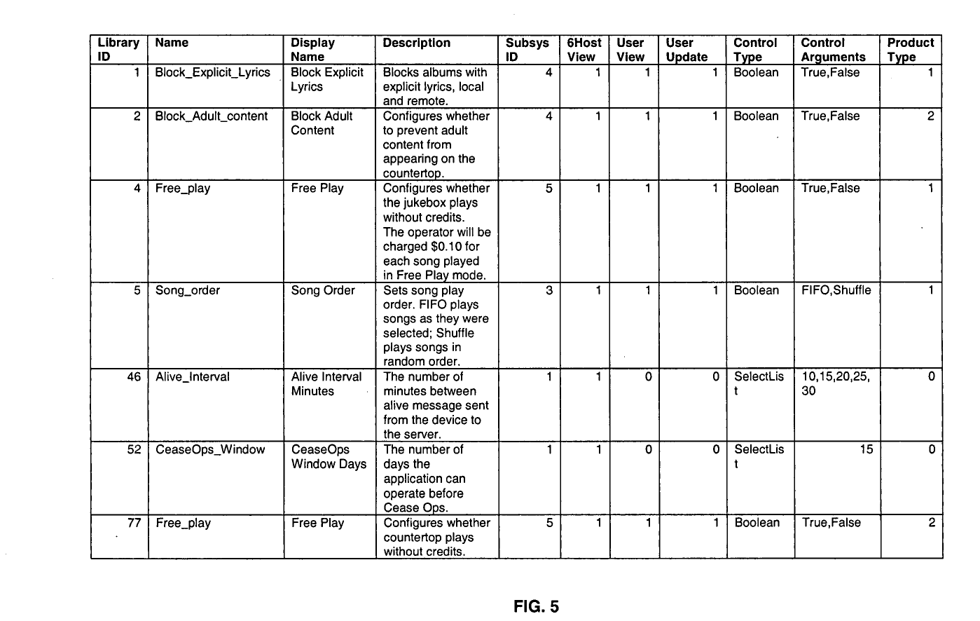

FIG. 4 is a block diagram illustrating a hierarchy of precedence levels for a system of entertainment devices, in accordance with embodiments of the present invention. Configuration setting values having a Level 0 precedence are applied to the entire system, so all of the entertainment devices would receive those configuration settings as their default. In other words, the configuration settings at Level 0 cascade downwards and are applied to all of the entertainment devices located below Level 0 in the hierarchy tree.

At Level 1, the entertainment devices are divided into subsets according to the product type. In the example shown, there are two product types in the system—jukeboxes and countertop units. At this level, the user can choose to apply a configuration setting value to all of the entertainment devices having the jukebox product type or the countertop unit product type. These configuration setting values are then applied to all of the entertainment devices in the selected product type category.

At Level 2, the entertainment devices are divided into subsets according to the operator managing the devices. Thus, configuration setting values provided at Level 2 are applied to all of the entertainment devices that subscribe to that setting and are managed by a particular operator. In the illustrated example, there are three operators in the system, Operator 1, Operator 2, and Operator 3, each operator being responsible for one or more entertainment devices. Thus, a configuration setting value set at precedence Level 2 for Operator 1 will be propagated to Jukeboxes 1, 2, and 3 at Locations 1 and 2. Similarly, a configuration setting value set at precedence Level 2 for Operator 2 will be propagated to Jukebox 4 at Location 3.

At Level 3, the entertainment devices are divided into subsets according to location. Thus, configuration setting values provided at Level 3 are applied to all of the entertainment devices located a particular venue. In the illustrated embodiment, a configuration setting value set at precedence Level 3 for Location 1 will be propagated to Jukeboxes 1 and 2.

Finally, at Level 4, the entertainment devices are divided by individual device. Thus, configuration setting values provided at Level 4 are applied to a particular entertainment device.

In this embodiment, the settings at Level 2 and Level 3 are limited to entertainment units of a single product type. This is done to improve the ease with which these settings are managed. In other embodiments, the settings that are propagated at different levels may not be limited to a particular product type. This may be more desirable, e.g., in implementations where the various product types are very similar, with few differences in settings. Thus, in embodiment shown in FIG. 4, configuration setting values entered by Operator 1 at Level 1 are only propagated either Operator 1's jukeboxes (Jukeboxes 1-3) or Operator 1's countertop units (Countertop 1), but not both. In other embodiments, Operator 1 may be able to make configuration settings at Level 1 that apply to all of Operator 1's devices, regardless of product type.

FIG. 5 is a partial view of an exemplary Setting Library 140, in accordance with embodiments of the present invention. The Setting Library 140 may be used to define all of the configuration settings that may be applied to the entertainment devices in the system. These definitions may be stored on the host system 100 and used to define the configuration setting values for all of the entertainment devices in the network. Each row in the Setting Library 140 corresponds to a single configuration setting. In FIG. 5, only seven entries are shown. However, in actual implementations, the number of entries may vary and can be in the hundreds or more.

The “LibraryID” provides an identification value to uniquely identify that particular configuration setting definition. Each configuration setting in the Setting Library 140 will have a unique LibraryID. The “Name” column shows a text string used to uniquely name the configuration setting within a subsystem and product type. As can be seen, there are two entries for “Free_Play”. The first entry with LibraryID 4 applies to only jukeboxes (e.g., ProductType 1) and the second entry with LibraryID 77 applies to only countertop units (e.g., ProductType 2). The “Display Name” column stores a text string describing the configuration setting for display in the user interface. The “Description” column stores an extended description of the configuration setting, which may also be displayed in the user interface.

The “SubsysID” column stores an identifier that is used for logically grouping related settings within the user interface. For example, Subsystem ID 1 corresponds to general system settings, Subsystem ID 4 corresponds to content filtering settings, and Subsystem ID 5 corresponds to pricing settings. Additional subsystem grouping identifiers may be used, depending on the desired organization for the user interface, as will be described in greater detail below. Alternatively, the Subsystem ID may be omitted altogether.

The “HostView” column contains a true/false (or 1/0) value that indicates whether this configuration setting is viewable via the browser-based interface. When the value is set to 0, the configuration setting is not displayed using the interface and is only viewable by directly accessing the database. The “User View” column contains a true/false (or 1/0) value that indicates whether this configuration setting is viewable by non-administrator users (e.g., operators or venue managers). When the value is set to 0, only system administrators may view this setting. The “User Update” column contains a true/false (or 1/0) value that indicates whether this configuration setting is editable by non-administrator users. When the value is set to 0, only system administrators may edit this setting.

The “ControlType” column contains a text string that indicates to the user interface application the type of data entry field to provide to a user for maintenance of the setting. For example, the ControlType may be a Boolean true/false value, a text field, a constrained drop-down list, etc. The “ControlArguments” column contains a text string that indicates to the user interface application the constrained values (if any) for the data entry field of the ControlType.

The “ProductType” column contains an identifier that is used to identify the product to which the configuration setting applies. A value of 0 indicates that the setting applies to all products, a value of 1 indicates that the setting applies to jukeboxes only, and a value of 2 indicates that the setting applies to countertop units only. In embodiments where the system includes more than two different types of entertainment devices, additional ProductType values may be provided.

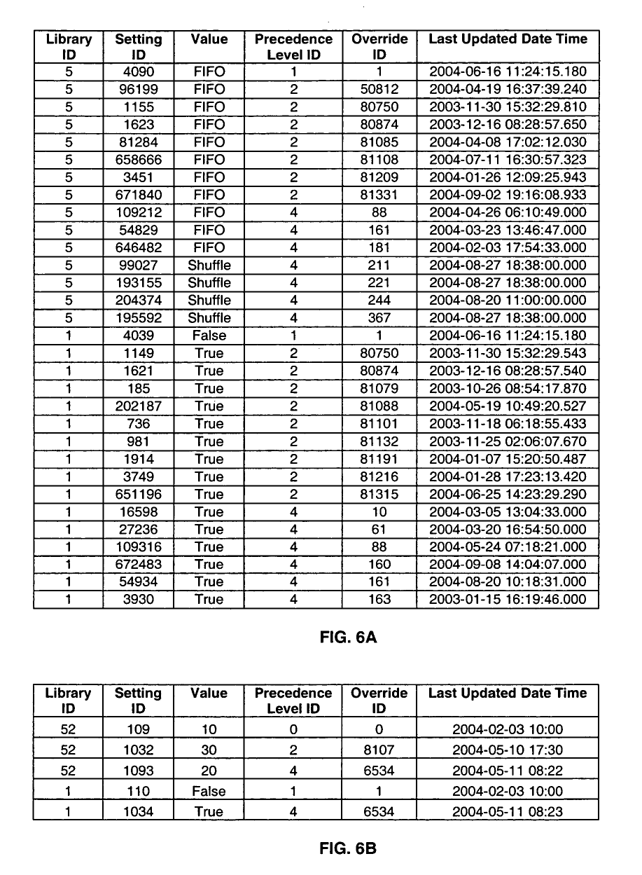

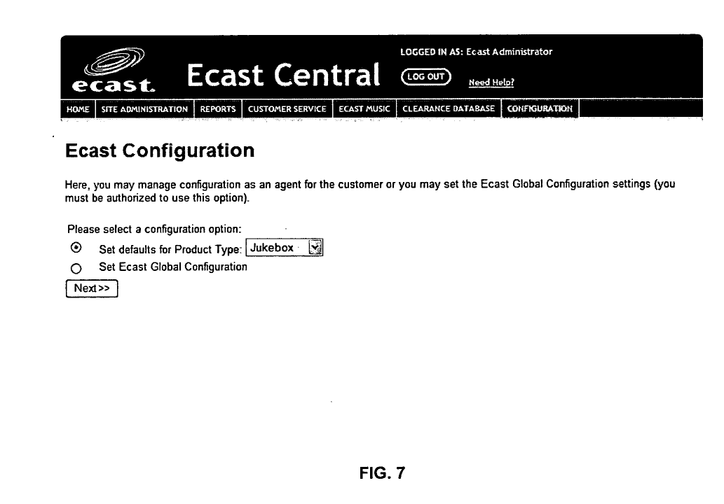

FIG. 6A is a partial view of a Setting Table for storing configuration setting values, in accordance with embodiments of the present invention. The Configuration Settings Database 108 on the host system 100 may store the configuration setting values for each entertainment device on the system in a Setting Table like that shown in FIG. 6A. In this embodiment, the configuration setting values for all of the devices on the system are stored in a single table, and every configuration setting defined in the Setting Library 130 will have at least one entry in the Setting Table. In other embodiments, the values may be stored in various ways, such as by using a database having a separate record for each individual device.

The “LibraryID” value contains the same unique setting identifier as shown in FIG. 5. The “SettingID” value contains a numeric identifier to uniquely identify that row in the Setting Table. This SettingID may be automatically generated each time a new configuration setting value is added to ensure that each entry in the Setting Table has a field that uniquely identifies that entry. “Value” contains the configuration setting value assigned to that setting. The “PrecedenceLevelID” value contains the numeric identifier corresponding to the precedence level (e.g., Level 0, Level 1, Level 2, Level 3, or Level 4) associated that the Value setting for that entry.

The “OverrideID” is a numeric key associating the Value setting with a business entity (e.g., a single entertainment device). The association of the Value setting and a business entity represented by the “OverrideID” differs based on the precedence level. For example, when the PrecedenceLevelID value is 0 (corresponding to a system level setting), then the OverrideID is also 0. When the PrecedenceLevelID value is 1 (corresponding to a product level setting), the value for the OverrideID is the ProductType value (e.g., 1 for jukeboxes or 2 for countertop units). When the PrecedenceLevelID value is 2 (corresponding to an operator level setting), the value for the OverrideID is a Customer ID retrieved from the Business Entity Tables 142. This Customer ID uniquely identifies each of the Operators in the system. When the PrecedenceLevelID value is 3 (corresponding to a location level setting), the value for the OverrideID is a Location ID retrieved from the Business Entity Tables 142. This Location ID uniquely identifies each of the locations in the system. When the PrecedenceLevelID value is 4 (corresponding to a single device level setting), the value for the OverrideID is a VendingSpaceID retrieved from the Business Entity Tables 142. This VendingSpaceID uniquely identifies each of the individual entertainment devices in the system. The “UpdateTime” column contains a date-time value to indicate when that setting value was last updated.

FIG. 6B shows a partial view of the Setting Table containing entries that are relevant to a single jukebox having VendingSpaceID 6534, which is managed by an operator having OperatorID 8107. In this example, there are three entries corresponding to the LibraryID 52 and two entries corresponding to the LibraryID 1. These duplicate entries correspond to configuration setting values set at different precedence levels. In FIG. 6B, the first entry for LibraryID 52 has a PrecedenceLevelID of 0, indicating that this setting value was the default setting for all entertainment devices in the system. This system-wide default value would generally be set by a system administrator of the host system 100. The second entry for LibraryID 52 has a PrecedenceLevelID of 2, indicating that this setting value was set for all of the devices managed by the operator having OperatorID 8107. The third entry for LibraryID 52 has a PrecedenceLevelID of 4, indicating that this setting value was set for this particular device having VendingSpaceID 6534.

The value at PrecedenceLevelID 4 may have been set by the same operator who also set the setting value at PrecedenceLevelID 2. This may occur when an operator wishes to have a general default setting for all of the devices managed by that operator, but wishes to customize individual devices with different settings. For example, an operator who manages a large number of jukeboxes located in video arcades frequented by children may wish by default to have all of the jukeboxes block songs with explicit lyrics. However, that operator may have a small number ofjukeboxes located in bars or other adult-only venues, so the operator may wish to override the default operator-level setting for each of those individual devices to allow music with explicit lyrics.

In accordance with embodiments of the present invention, where multiple configuration setting values are provided at different precedence levels, the value associated with the highest numeric precedence level will be used to configure the device. As shown in FIG. 4, the precedence levels increase as one traverses into lower tiers. For example, the value at precedence Level 4 will override the value at precedence Level 2.

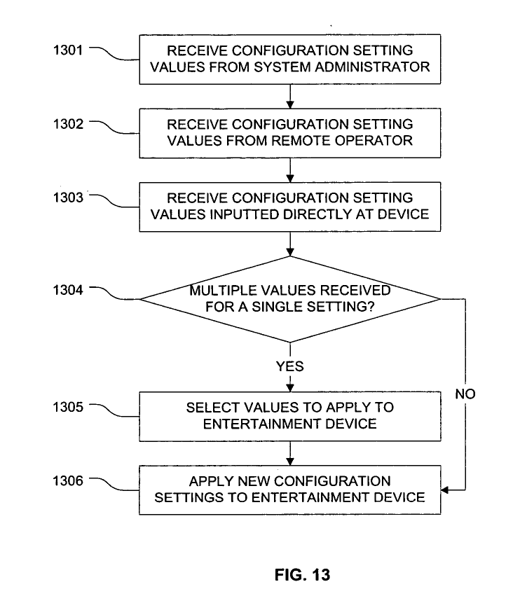

FIG. 13 is a flowchart showing an exemplary process for updating configuration settings in accordance with embodiments of the present invention. In step 1301, configuration setting values are received from a system administrator. The system administrator may transmit these values to the host system 100 using the user interface described below. In step 1302, configuration setting values are received from a remote operator. Similarly, the operator may transmit these values to the host system 100 using the user interface described below. In step 1303, configuration setting values are inputted directly into the entertainment device. In step 1304, if multiple values are received for a single setting, the appropriate value to be applied to the entertainment device is selected. Then, in step 1305, the new configuration setting values are applied to the entertainment device.

In accordance with embodiments of the present invention, a web-based interface may be provided to allow users to remotely modify configuration settings. Those updated configuration setting values may then be propagated to one or more entertainment devices, depending on the precedence level assigned to the updated value. FIGS. 7-12 are exemplary screen shots of a web-based configuration management interface.

FIG. 7 shows a welcome screen for managing configuration settings. In this screen, a user can select one of two radio buttons. The first selection corresponds to Level 1, in which configuration setting values are applied to one of the available product types. The second selection corresponds to Level 0, in which configuration setting values are applied to all of the devices in the system.

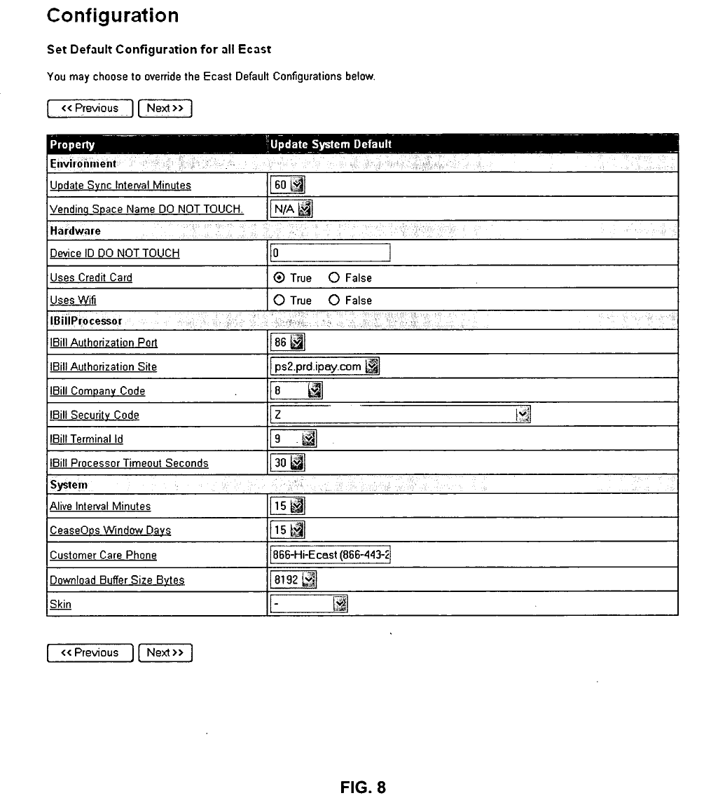

FIG. 8 shows the setting update screen provided if the second selection in FIG. 7 is chosen. This update screen enables a user to modify the default settings for all entertainment devices. In this screen, the configuration settings are grouped into four subsystems: Environment, Hardware, IBillProcessor, and System. Additional groupings of configuration settings may be provided on subsequent screens which are accessed by clicking on the “Next>>” button. The first configuration setting on this screen is “Update Sync Interval Minutes”, which determines the frequency with which each device will attempt to retrieve updated software from the host server 100. The configuration value shown is 60 minutes.

The next two configuration settings are “Vending Space Name DO NOT TOUCH” and “Device ID DO NOT TOUCH”. Both of these settings include a warning against modifying the values because these are settings that are unique to either the venue location or the individual device and should not have a default setting. These warnings are embedded into the DisplayName so that they are always shown in the user interface. Alternatively, these configuration settings can be simply hidden from the user interface in order to prevent inadvertent modifications.

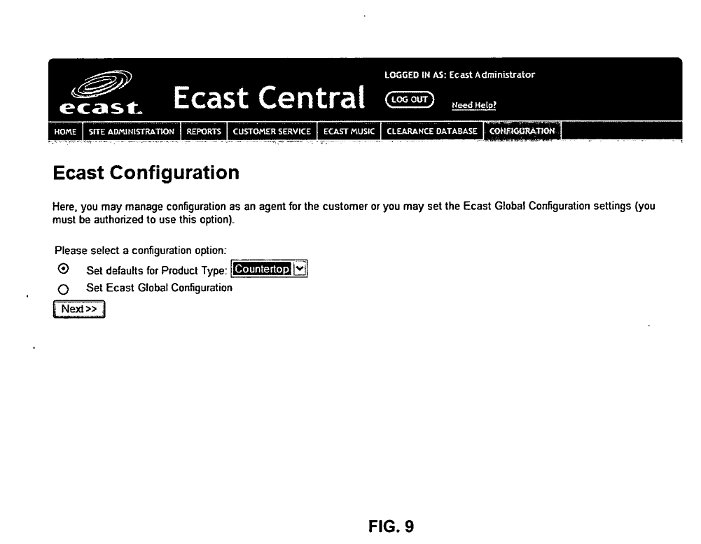

FIG. 9 shows the welcome screen for managing configuration settings in which the Level 1 selection is chosen. When the radio button for “Set defaults for Product Type” is chosen, a pull-down menu is provided to allow the user to select from a plurality of constrained values. In this embodiment, the user may only choose either the jukebox product or the countertop unit product.

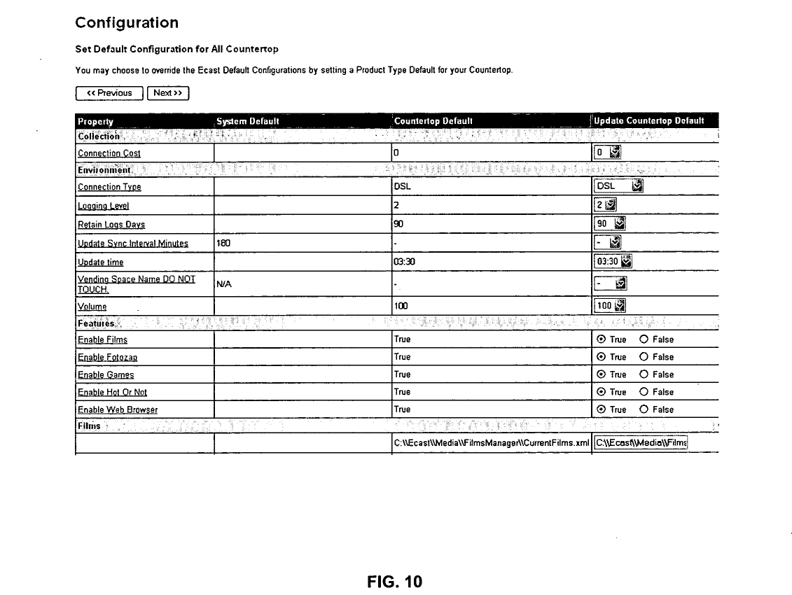

FIG. 10 shows the setting update screen provided when the countertop Product Type is chosen. This update screen enables a user to modify the default settings for all countertop units in the system. In this screen, the configuration settings are grouped into four subsystems: Collection, Environment, Features, and Films. Additional groupings of configuration settings may be provided on subsequent screens which are accessed by clicking on the “Next>>” button.

For each setting in this screen, there are three associated columns. The first column (“System Default”) displays the default value provided at the system level (Precedence Level 0), if any has been set. The second column (“Countertop Default”) displays the existing default value provided at the product level (Precedence Level 1), if any has already been set. The third column (“Update Countertop Default”) enables a user to modify the existing countertop default settings.

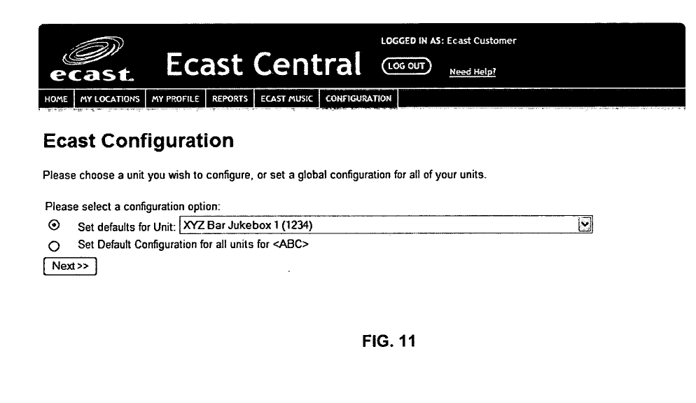

FIGS. 7-10 show screen shots of configuration setting management screens that would be made available to host system personnel. FIG. 11 shows a welcome screen that would be provided for operators who log into the management system. Here, the operator accessing the configuration interface using a web browser can select one of two radio buttons. The first selection corresponds to Level 4, in which configuration setting values are to be applied to a particular device (shown here as XYZ Bar Jukebox 1, VendingSpaceID 1234). The second selection corresponds to Level 2, in which configuration setting values are applied to all of the devices of a single product type associated with that operator (shown here as ABC Company). In this example, the Level 3 location level settings are not used. If the Level 3 settings were used, the operator may see an additional option in this screen allowing the operator to make configuration setting changes to all of the operator's devices located at a particular venue.

The identity of the user accessing the management system can be established, e.g., by requiring the user to enter a user name and password. This user name can be associated with a particular Customer ID or with a system administrator identity. In this interface, when an operator logs onto the system, the configuration settings associated with UserView values of 0 will not be shown, since the interface is provided for operators, not system-level personnel. The pulldown options in FIG. 11 may also be determined based on the Customer ID such that an operator may only access the configuration setting update screens for that operator's devices. The entertainment devices managed by other operators may be hidden from view.

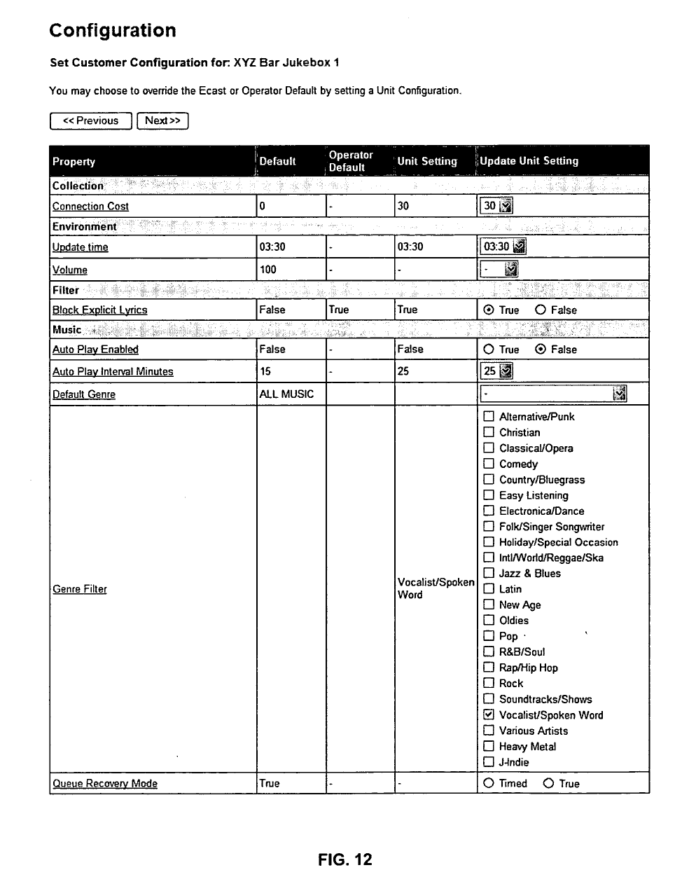

FIG. 12 shows the setting update screen provided if the first selection in FIG. 11 is chosen. This update screen enables a user to modify the configuration setting values for all entertainment devices located at the XYZ Bar. In this screen, the configuration settings are grouped into four subsystems: Collection, Environment, Filter, and Music. Additional groupings of configuration settings may be provided on subsequent screens which are accessed by clicking on the “Next>” button.

For each configuration setting in this interface, there are four associated columns. The first column (“Default”) displays the default value provided at either the system level (PrecedenceLevelID 0) and product level (PrecedenceLevelID 1). As described above, when default settings are provided at both PrecedenceLevelID 0 PrecedenceLevelID 1, the higher numeric precedence level will be applied as the default. In practice, because both the PrecedenceLevelID 0 and PrecedenceLevelID 1 values are set by the host system administrator, conflicts should not occur and the values should be provided at either of the precedence levels, but not both. However, the precedence-based assignment may still be utilized where the administrator has inadvertently assigned values to a single setting at both the 0 and 1 precedence levels. In this case, the values provided at Level 0 and Level 1 are combined into a single Default display. This is because the distinction between values set at the Level 0 and Level 1 tiers is relevant only to system administrators, and does not need to be communicated to operators. Thus, to simplify the interface, the Level 0 and 1 default values are combined seamlessly to the operator.

The second column (“Operator Default”) displays the existing default value provided at the operator level (Level 2), if any. The third column (“Unit Setting”) displays the existing value for each configuration setting at the device level (Level 4). The fourth column (“Update Unit Setting”) allows the user to modify the configuration setting for that device. Thus, the interface enables a user to view how the values provided at the various precedence levels are applied in a cascading fashion to lower level tiers, and provides the user with the ability to edit the configuration setting values, as appropriate.

The updated configuration setting values may be propagated to the individual entertainment devices in various ways. In the embodiments described above, the changes made using the interfaces shown in FIGS. 7-12 are stored in the Setting Table on the host system 100. A periodic update message may be periodically generated by the host system 100 and transmitted to the individual devices over the network 130. In some embodiments, each device is configured to periodically request a status update request to the host system 100. This request may be generated on a regular schedule, such as, e.g., every five minutes, once per day, or once per week. When the host system 100 receives a status update request from an entertainment device, the host system 100 may check to determine whether any updates have been made to that device's settings since the last time the host system 100 generated an update message. The determination of whether any updates have been made can be accomplished in a variety of ways. In some embodiments, an UpdateNeeded flag is set to true every time a configuration setting is modified and is set to false every time an update message is generated. Accordingly, in response to receiving a status update request from an entertainment device, the host system 100 can check the UpdateNeeded flag. If the flag is true, the host system 100 can then generate the new update message. If the flag is false, the host system 100 will notify the device that no new settings are available. This UpdateNeeded flag can be stored in, e.g., the business entity tables 142, the configuration settings database 108, or in another location accessible by the host system 100.

The update message from the host system 100 can take various forms. In the present example, the host system 100 will first search the Setting Table to retrieve only those configuration setting values that relate to the entertainment device requesting the updates. Next, the host system 100 will generate an XML message containing all of the retrieved configuration setting values and will transmit the message using the message server 102 to the entertainment device. When the entertainment device receives the XML message, it retrieves the values for each configuration setting.

In this embodiment, the host system 100 will only retrieve and transmit those configuration setting values that correspond to the highest precedence levels. Thus, if the Setting Table includes a particular configuration setting that has a value set at Precedence Level 0 and another value set at Precedence Level 1, only the value associated with the Precedence Level 1 will be transmitted in the XML message. In other embodiments, the host system 100 may retrieve and transmit all of the configuration setting values that relate to the requesting device. The requesting device can then sort through the values and apply only those values at the highest precedence level. The queries can be executed in a variety of ways. For example, in the present embodiment, the host system 100 runs five queries: first, a query for all Level 0 setting values; second, a query for all Level 1 setting values corresponding to the type of product requesting the update; third, a query for all Level 2 setting values corresponding to the operator who manages the requesting device; fourth, a query for all Level 3 setting values corresponding to the location of the requesting device, and fifth, a query for all Level 4 setting values corresponding to the DeviceID of the request device. Each time a query is run, any new values obtained are used to override the values from the lower precedence levels. Other variations are possible.

Once the setting update message is received by the device, the device may perform an arbitration to determine whether the newly received settings conflict with any settings already existing on the device. This arbitration may be performed by comparing the last update time stamp for each newly received setting with the last update time stamp for each existing setting on the device. Because some small delays may be introduced during the update process, e.g., caused by network congestion or by differences in the precision of recording time stamps in different systems, the device may be configured to disregard insignificant time differences (e.g., time differences of less than 2 seconds may be disregarded). If the device determines any existing setting on the device has been updated more recently than the corresponding newly received setting, the device can perform some sort of reconciliation function. In some embodiments, the device may simply select the setting that was more recently changed, regardless of the source of the change. It may also be desirable for the device to transmit a message back to the host system indicating that a setting has been changed locally more recently. The host system may then update the Setting Table to reflect that the locally-created setting has been chosen.

When the host system receives updated settings from the device that conflict with settings existing on the host system, the host system may also perform a similar arbitration function to determine which setting values to adopt. Again, in some embodiments, it may be desirable to simply adopt the most recently updated setting values, regardless of the source. In other embodiments, the device may preferentially select the setting from a particular source. For example, in the event of any conflict, the device may always favor any setting values inputted directly into the device over any setting values inputted through the host system. Other variations are possible.

In some embodiments, the host system may be configured to generate a full override setting update message. This full override setting update message will transmit a set of setting values to the device and will instruct the device to implement all of these setting values, regardless of the time stamp on the local settings. This may be useful, for example, if the data storage device (e.g., a hard drive) containing a first device's settings is moved to a different second device. This event may be referred to as a “drive move.” In this case, it may be desirable to maintain the previous settings from the second device, even though the setting values stored on the data storage device are different. Thus, it may be desirable to enable the host system to override all of the existing settings on the data storage device for the second device. This can be accomplished, for example, by including an OverrideAll flag in the XML update message to instruct the updating entertainment device to apply all of the new configuration setting values and to ignore any time-based arbitrations.

It may also be desirable for each entertainment device to receive a complete set of configuration setting values on a regular basis, regardless of the status of the UpdateNeeded flag. This can be performed, for example, on a daily basis when the entertainment device is set to reboot. This may be desirable as a fallback to ensure that all devices obtain the most updated configuration setting values, even if the UpdateNeeded flag is not set to true for some reason. This may also be desirable if the administrator wishes to delay the propagation of the new settings.

As described above, every entry in the Setting Table includes a field indicating the precedence level. As shown in FIG. 6B, a particular setting may have multiple entries if values are provided for that setting at multiple precedence levels. For example, the LibraryID 52 has two entries in the Setting table. The first entry (Setting ID 1032) corresponds to a value assigned at precedence level 2 for customer ID 8107 and the second entry (Setting ID 1093) corresponds to a value assigned at precedence level 4 for VendingSpace 6534.

As described above, the configuration setting values may be stored in various ways. In the embodiment above, all of the configuration setting values at all precedence levels for all of the devices are stored in a single Setting Table. In other embodiments, a single Setting Table may be used for each individual unit, but with only a single entry corresponding to each configuration setting. That entry would correspond to the value provided at the highest precedence level. In yet other embodiments, multiple tables may be used for each device, each table storing values for a different precedence level. Then, when the host system 100 generates the update message, the appropriate setting values may be selected from these tables. Numerous other variations are possible.

In accordance with embodiments of the present invention, three user interface modes may be provided for making changes to configuration settings. First, a web-based interface having limited access to the various configuration settings may be provided for use by operators. Second, an operator screen may be provided locally at the device so that updates can be made directly into the device. This interface can be web-based, like the first interface, or may utilize the processing power and touch screen input of the entertainment device to provide a more elaborate and user-friendly interface. Again, it may be desirable to limit the configuration settings that are viewable and editable at this interface. Finally, a system administrator interface may be provided to enable host system administrators to access the host system. This system administrator would generally be given the ability to view and edit all configuration settings. At various levels, it may be desirable to hide some settings to certain categories of users and/or provide different interfaces. This can be done based on an assessment of whether access to that setting is appropriate and on the sophistication of the expected user.

The ability to update configuration setting values directly into the entertainment device provides flexibility for the operators and venue managers in managing the devices. However, it may be desirable to ensure that any configuration setting values inputted into the device are synchronized with the values that are stored in the Setting Table on the host system 100 and that any conflicts with configuration setting values inputted elsewhere (e.g., by the operator via the browser-based application or by the system administrator) are resolved. To do this, when new configuration setting values are inputted directly into an entertainment device, that device may transmit an update message to the host system 100, containing the updated values and associated data (e.g., precedence level and update time). This transmission may occur immediately after the setting values are inputted or may occur after some delay, such as according to a periodic update schedule.

The host system 100 may receive these setting values and store the values in the Setting Table in the same way that it stores setting values inputted by the operator using the browser-based interface. However, when receiving setting values directly from the device that apply only to that device, the UpdateNeeded flag is not set to true because there is no need to transmit the setting values back to the device again. In some embodiments, the interface on the device only enables a user to input new values that apply at the device level (e.g., precedence Level 4). In other embodiments, the device's interface may enable a user to input directly into the device a configuration setting value that applies to a different precedence level. Thus, if a user inputs directly into an entertainment device values for any configuration settings that apply to multiple entertainment devices, when those new settings are synchronized with the host system, the host system will then propagate those setting values to all of the other impacted entertainment devices. This way, an operator using the interface at a jukebox may enter configuration setting values having a Level 2 precedence, and those values will be propagated to all of the operator's other jukeboxes.

While the invention has been described in terms of particular embodiments and illustrative figures, those of ordinary skill in the art will recognize that the invention is not limited to the embodiments or figures described. For example, in many of the embodiments described above, there are five tiers of precedence levels. In other embodiments, greater or fewer levels may be used. In addition, the ways in which the entertainment devices are grouped at each precedence level may vary.

The embodiments described herein show either freestanding jukebox or countertop devices. In other embodiments, the entertainment devices may take other forms and may provide different types of entertainment content. The configuration settings associated with these different types of entertainment content may also vary.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

We claim:

1. A method of managing a remote entertainment device having a set of configuration settings, comprising:
storing values for a first subset of configuration settings from the set of configuration settings, each of the values for the first subset having an associated precedence level from a plurality of precedence levels;
storing values for a second subset of configuration settings, each of the values for the second subset having an associated precedence level from the plurality of precedence levels; and
transmitting a third subset of configuration setting values containing values from the first and second subset of configuration settings to a remote entertainment device.

2. The method of claim 1, further comprising:
compiling the third subset of configuration setting values from the first and second subsets of configuration setting values such that if a configuration setting value from the first subset applies to the same configuration setting as a configuration setting value from the second subset, selecting the configuration setting value having the higher precedence value to include in the third set of configuration setting values.

3. The method of claim 2, wherein:
the plurality of precedence levels comprises a system-based precedence level corresponding to values to be applied by default to a set of remote entertainment devices.

4. The method of claim 3, wherein:
the plurality of precedence levels comprises a product-based precedence level corresponding to the entertainment devices in the set of remote entertainment devices having a particular product type, the product-based precedence level having a higher precedence value than the system-based precedence level.

5. The method of claim 3, wherein:
the plurality of precedence levels comprises an operator-based precedence level corresponding to the entertainment devices in the set of remote entertainment devices managed by a particular entity, the operator-based precedence level having a higher precedence value than the system-based precedence level.

6. The method of claim 3, wherein:
the plurality of precedence levels comprises a venue-based precedence level corresponding to the entertainment devices in the set of remote entertainment devices located at a particular venue, the venue-based precedence level having a higher precedence value than the system-based precedence level.

7. The method of claim 3, wherein:
the plurality of precedence levels comprises a device-based precedence level corresponding to a particular remote entertainment device, the device-based precedence level having a higher precedence value than the system-based precedence level.

8. The method of claim 5, wherein:
the plurality of precedence levels comprises a device-based precedence level corresponding to a particular remote entertainment device, the device-based precedence level having a higher precedence value than the system-based precedence level and the operator-based precedence level.

9. The method of claim 1, further comprising:
receiving values for the second subset of configuration settings from a user over a network connection.

10. The method of claim 9, wherein:
said receiving values for the second subset of configuration settings comprises receiving values inputted into a browser application.

11. The method of claim 1, further comprising:
said receiving values for the second subset of configuration settings from the user comprises receiving values for the second subset of configuration settings inputted directly into the remote entertainment device.

12. The method of claim 1, wherein:
the third subset of configuration setting values comprises configuration setting values that control the performance of entertainment content at the remote entertainment device.

13. The method of claim 12, wherein:
at least one of the transmitted third subset of configuration setting values relates to cost per song play.

14. The method of claim 1, wherein:
said transmitting the third subset of configuration setting values to the remote entertainment device comprises transmitting the third subset of configuration setting values to a plurality of remote entertainment devices.

15. A host system for managing a remote entertainment device having a plurality of configuration settings, comprising:
a configuration database storing a plurality of values for each configuration setting, each of the plurality of values having an associated precedence level from a plurality of precedence levels used to determine which of the plurality of values to apply to each configuration setting on the remote entertainment device; and
a host system controller configured to:
compile a subset of configuration setting values from the set of configuration setting values; and
transmit the subset of configuration setting values to the remote entertainment device.

16. The system of claim 15, wherein:
the host system controller is configured to compile the subset of configuration setting values such that for each of the at least one configuration settings having the plurality of associated values, the subset of configuration setting values includes the value having the highest precedence level.

17. The system of claim 15, wherein:
the host system controller is configured to receive a second subset of configuration setting values from a user over a network connection.

18. The system of claim 15, wherein:
the host system controller is configured to receive a second subset of configuration setting values from a user directly inputted into the remote entertainment system.

19. The system of claim 15, further comprising:
a setting library defining the plurality of configuration settings.

20. The system of claim 15, further comprising:
a business entity database storing information regarding the plurality of remote entertainment devices.

21. The system of claim 15, wherein:
the plurality of precedence levels comprises a system-based precedence level corresponding to values to be applied by default to a set of remote entertainment devices.

22. The system of claim 21, wherein:
the plurality of precedence levels comprises a product-based precedence level corresponding to the entertainment devices in the set of remote entertainment devices having a particular product type, the product-based precedence level having a higher precedence value than the system-based precedence level.

23. The system of claim 21, wherein:
the plurality of precedence levels comprises an operator-based precedence level corresponding to the entertainment devices in the set of remote entertainment devices managed by a particular entity, the operator-based precedence level having a higher precedence value than the system-based precedence level.

24. The system of claim 21, wherein:
the plurality of precedence levels comprises a venue-based precedence level corresponding to the entertainment devices in the set of remote entertainment devices located at a particular venue, the venue-based precedence level having a higher precedence value than the system-based precedence level.

25. The system of claim 21, wherein:
the plurality of precedence levels comprises a device-based precedence level corresponding to a particular remote entertainment device, the device-based precedence level having a higher precedence value than the system-based precedence level.

26. The system of claim 23, wherein:
the plurality of precedence levels comprises a device-based precedence level corresponding to a particular remote entertainment device, the device-based precedence level having a higher precedence value than the system-based precedence level and the operator-based precedence level.

27. A method of updating a remote entertainment device having a set of configuration settings, comprising:
assigning a first set of values to a first subset of configuration settings from the set of configuration settings;
receiving a second set of values for a second subset of configuration settings over a network connection;
compiling a group of configuration setting values from the first and second sets of values such that such that if a configuration setting value from the first set of values applies to the same configuration setting as a configuration setting value from the second set of values, selecting the value from the second set of values to apply to the remote entertainment device; and
transmitting the group of configuration setting values to the remote entertainment device.

28. The method of claim 27, wherein:
said transmitting the group of configuration setting values to the remote entertainment device comprises transmitting the group of configuration setting values to a plurality of remote entertainment devices.

29. The method of claim 28, further comprising:
receiving a third set of values for a third subset of configuration settings over the network connection;
wherein said transmitting the group of configuration setting values to the plurality of remote entertainment devices comprises transmitting the plurality of configuration setting values to the plurality of remote entertainment devices such that the second set of values are applied to each of the plurality of remote entertainment devices and the third set of values are applied to exactly one of the plurality of remote entertainment devices.

30. The method of claim 28, further comprising:
receiving a third set of values for a third subset of configuration settings from the user over the network connection;
wherein said compiling the group of configuration setting values comprises compiling the group of configuration setting values from the first, second, and third sets of values such that such that if a configuration setting value from the first set of values applies to the same configuration setting as a configuration setting value from the second set of values, selecting the value from the second set of values to apply to the remote entertainment device, and if a configuration setting value from the third set of values applies to the same configuration setting as a configuration setting values from either the first or second sets of values, selecting the value from the third set of values to apply to the remote entertainment device.

31. The method of claim 27, wherein:
the transmitted plurality of configuration setting values comprise configuration setting values that control the performance of entertainment content at the remote entertainment device.

32. The method of claim 31, wherein:
at least one of the transmitted plurality of configuration setting values relates to a cost for performance of the entertainment content.

33. The method of claim 27, wherein:
said receiving values for the second subset of configuration settings over the network connection comprises receiving values inputted into a browser application.

34. The method of claim 27, wherein:
said receiving values for the second subset of configuration settings over the network connection comprises receiving values inputted directly into the remote entertainment device.

35. The method of claim 27, wherein:
said receiving values for the second subset of configuration settings over the network connection comprises receiving values inputted directly into the remote entertainment device.

36. The method of claim 35, further comprising:
providing a user interface at the remote entertainment device allowing a user to directly input configuration setting values;
receiving through the user interface configuration setting values for a third subset of configuration settings; and
applying the third subset of configuration setting values to the remote entertainment device.

37. The method of claim 36, further comprising:
transmitting the third subset of configuration settings from the remote entertainment device to a host system; and
storing the third subset of configuration settings at the host system.

38. A method of updating configuration settings on remote entertainment devices, comprising:
providing a configuration setting interface to a user over a network connection;
receiving a first set of configuration setting values from the user over the network connection; and
transmitting the first set of configuration setting values to a plurality of remote entertainment devices.

39. The method of claim 38, further comprising:
storing a second set of configuration setting values, wherein each of the configuration setting values in the first and second sets of configuration setting values has an associated precedence value; and
compiling a third set of configuration setting values from the first and second sets of configuration setting values such that if a configuration setting value from the first set of configuration setting values received from the user applies to the same configuration setting as a configuration setting value from the second subset of configuration setting values, selecting the configuration setting value having the higher precedence value to include in the third set of configuration setting values.

40. The method of claim 39, further comprising:
transmitting the third set of configuration setting values to the plurality of remote entertainment devices.

41. The method of claim 38, further comprising:
displaying a second set of configuration setting values to the user;
wherein if a configuration setting value received from the user conflicts with a configuration setting value in the second set of configuration setting values, selecting the configuration setting value received from the user to apply to the plurality of remote entertainment devices.

42. The method of claim 38, wherein:
said receiving the first set of configuration setting values from the user over the network connection comprises receiving values inputted by the user into a browser application.

43. The method of claim 38, wherein:
said receiving the first set of configuration setting values from the user over the network connection comprises receiving values inputted directly by the user into the remote entertainment device.

44. The method of claim 38, wherein:
the first set of configuration setting values comprise configuration setting values that control the performance of entertainment content at the remote entertainment device.

45. The method of claim 44, wherein:
at least one of the first set of configuration setting values relates to cost per song play.

46. A method of configuring a plurality of entertainment devices, comprising:
storing default values for a plurality of configuration settings governing operation of the plurality of entertainment devices;
providing an interface to a user for entering values for the configuration settings;
receiving configuration setting values from the user; and
propagating a set of configuration setting values to a plurality of jukebox systems, the propagated configuration setting values including the received configuration setting values and the default values for which there are no corresponding received configuration setting values.

47. The method of claim 46, wherein:
said providing the interface to the user comprises displaying default values for the plurality of configuration settings to the user and providing an input field to the user for entering values for the configuration settings to override the default values.

48. The method of claim 47, wherein:
said providing the interface to the user comprises displaying some of the default values for the plurality of configuration settings to the user and hiding some of the default values for the plurality of configuration settings from the user.
